(19) United States
(12) Patent Application Publication
(10) Pub. No.: US 2002/0032047 A1
(43) Pub. Date: Mar. 14, 2002

(54) System and method for radiation-free cellular telephone communication

(76) Inventor: Ronen Ingbir, Ramat Ef'al (IL)

Correspondence Address: DR. MARK FRIEDMAN LTD., c/o Bill Polkinghorn - Discovery Dispatch, 9003 Florin Way, Upper Marlboro, MD, 20772, US

(21) Appl. No.: 09/864,399

(22) Filed: May 25, 2001

(30) Foreign Application Priority Data
May 30, 2000 (IL) 136463

(51) Int. Cl. H04M 1/00

(52) U.S. Cl. 455/569; 455/557

(57) ABSTRACT

The invention involves converting electric signals into mechanical waves, preferably ultrasonic or subsonic waves. No electric current is involved in the transmission of said mechanical waves. For that reason, the user of the present invention is not exposed to hazardous electromagnetic radiation, as the users of cellular phones of the prior art. In addition, mechanical waves are not interfered by strong magnetic fields.

### BACKGROUND OF THE INVENTION

1. Field of the Invention

The present invention relates to a transmission device such as a cellular telephone and, more particularly, to a system for using a transmission device without producing potentially hazardous radiation near the body of users. In addition, the present invention relates to the use of mechanical waves that are not perceptible by the ear for the transmission of signals between communication devices.

2. Description of the Prior Art

Cellular phones are becoming omnipresent and necessary elements as society enters the new millennium. Unfortunately, operating on radio frequency transmission, these phones are also sources of electromagnetic radiation. Most phones include an antenna that is placed close to the user's head. Emitted radiation from this antenna is suspected to be hazardous to users. Attempts to reduce the emitted radiation by placing a shield around the antenna have been found to be impractical and thus have not been commonly employed in cellular telephones. Another proposed solution is to avoid placing the antenna near the head of the user. Proposed and now commonly available is an electrical wire that is connected to the telephone at the input/output port of the cellular phone and terminating with an earphone that is placed in the user's ear. Electrical microphone is mounted on the wire near the earphone, putting it at the level of the mouth of the user when the earphone is placed in the ear. In such an arrangement, the telephone may be clipped to a user's belt or placed in a pocket or a purse, with the wire extending therefrom. The earphone is placed in the user's ear. When the user receives or makes a telephone call, the user merely activates the “send” or similar button on the cellular telephone to complete the call hands free. The user hears through the earphone, the other party hearing the user through the signal picked up by the microphone which is in proximity of the mouth. However, such configuration may prevent the user from moving head and hands freely unless continuously paying attention to the path of the electrical wire. Another configuration of cellular telephones in use includes a loudspeaker coupled directly to and mounted on a cellular telephone. The user can hear the emitted sounds with no need to hold the cellular telephone close to head. However, since a loudspeaker is used instead of an earphone, privacy is denied unless the user is alone.

Not only do these solutions provide for hands free operation of the telephone, they were also believed to have resolved the problem of unwanted radiation near the user's head, the telephone being remote therefrom. Unfortunately, recent studies conducted in Britain in 2000 have shown that such a wire configuration does not reduce radiation near the user's head.

There have been number of attempts aimed at solving the problem of potentially hazardous radiation emitted from cellular telephones.

U.S. Pat. No. 4,090,042 relates to acoustical communications headset including tubes for the transmission of sound.

U.S. Pat. No. 5,528,689 relates to a method for converting a cellular telephone into a headset telephone. U-shaped clips are used for attaching a mouth cup and an ear cup to the cellular telephone. However, there is still a problem that might evolve from disposition of these cups. Such disposition will interfere significantly with the smooth operation of the cellular telephone, since too much noise from the surroundings might be picked up by the microphone, or alternatively mask the sound coming from the earphone. In addition, headset adjustment to user's head is done by a complicated mechanism that may easily dismembered.

U.S. Pat. No. 5,613,222 relates to a hands-free cellular phone that employ acoustical tubes. A receiving cup is attached to the speaker of the cellular telephone by loop type Velcro fasteners. However, Velcro straps can still be bulky and accidentally detached. Such disposition will interfere significantly with smooth operation of the cellular telephone, since too much ambient noise from surrounding might be picked up by the microphone.

While these devices fulfill their particular objectives and requirements the aforementioned devices are not effective when the telephone has to be located more than ten feet away from the user, since longer acoustical tubes absorbs too much noise from surroundings.

In addition, receiving and transmitting of sound waves between the cellular phone and the user is not mediated by any apparatus capable of amplifying, coding, decoding, filtering, or conferring any other change on the sounds heard or spoken. Such apparatus, hereafter called a conversion device, is required especially when using the cellular phone near a source of loud noise.

There is therefore a need for producing a cellular telephone employing neither electrical wires nor acoustical tubing that can be employed in a noisy environment and/or close to a strong magnetic field.

### SUMMARY OF THE INVENTION

According to one aspect of the present invention, there is provided a communication system containing communication devices that emit reduced electromagnetic radiation. Radiation reduction is acquired by positioning the antenna of a cellular telephone far from the head of the user, and using a conversion device for the transmission of low-radiation signals or acoustical signals between a transmission device and an earphone placed in user's ear. The system comprises a transmission device such as a cellular phone, a conversion device for converting a signal of a first type to a signal of a second type and an electrical coupler for coupling the cellular phone and the conversion device.

According to one feature in the described preferred embodiment of the invention described below, said signal of a first type and said signal of a second type are each independently selected from the group consisting of an electric signal, an acoustical signal and an electromagnetic signal.

According to another feature of the present invention there is provided a communication system containing communication devices that emit no electromagnetic radiation, wherein at least one item selected from the group consisting of said electrical coupler and said at least one conversion device are attached to or integrally formed with the transmission device.

According to yet another feature of the present invention there is provided a communication system containing communication devices that emit no electromagnetic radiation, wherein said acoustical signal is conveyed by an acoustical tube.

According to further features in preferred embodiments of the invention described below, wherein said acoustical signal travels in a first direction via a first acoustical tube, and travels in a second direction via a second acoustical tube.

According to still another feature of the present invention there is provided a communication system containing communication devices that emit no electromagnetic radiation, wherein said first and second acoustical tubes are connected to one another.

According to an additional feature of the present invention there is provided a communication system containing communication devices that emit no electromagnetic radiation, wherein said first and second acoustical tubes are concentric.

According to another aspect of the present invention there is provided a method for reducing radiation exposure to a user of a transmission device.

According to still another feature of the present invention there is provided a method for reducing radiation exposure to a user of a transmission device, wherein said signal of a first type and said signal of a second type are each independently selected from the group consisting of an electric signal, an acoustical signal and an electromagnetic signal.

According to an additional feature of the present invention there is provided a method for reducing radiation exposure to a user of a transmission device, comprising the additional step of attaching to or integrally forming with the transmission device at least one item selected from the group consisting of said electrical coupler and said at least one conversion device.

According to yet additional feature of the present invention there is provided a method for reducing radiation exposure to a user of a transmission device, comprising the additional step of conveying said acoustical signal by an acoustical tube.

According to still additional feature of the present invention there is provided a method for reducing radiation exposure to a user of a transmission device, wherein conveying of said acoustical signal in a first direction occurs in a first acoustical tube, and conveying of said acoustical signal in a second direction occurs in a second acoustical tube.

According to further feature in preferred embodiments of the invention described below, there is provided a method for reducing radiation exposure to a user of a transmission device, comprising the additional step of connecting said first and second acoustical tubes to one another.

According to still further features in the described preferred embodiments of the invention described below, there is provided a method for reducing radiation exposure to a user of a transmission device wherein said first and second acoustical tubes are concentric.

According to yet another aspect of the present invention there is provided a device for converting a signal of a first type to a signal of a second type, both signals are independently selected from the group consisting of an electric signal, an acoustical signal and an electromagnetic signal.

The present invention successfully addresses the shortcomings of the prior art configurations by providing a technique for the transmission of signals between communication devices such as cellular telephones and computers. Also, said signals may be transmitted through open air by ultrasonic or subsonic waves. The transmission of signals through open air make users free to move head and hands with no need to continuously pay attention not to pull the wire.

Another advantage of the present invention is that it can be used for the transmission of signals near sources of strong magnetic fields, such as magnetic resonance imaging (MRI) systems without being distorted.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a prior art cellular telephone;

FIG. 2 shows one preferred embodiment of a cellular telephone system according to the present invention;

FIG. 3 shows an additional preferred embodiment of a cellular telephone system according to the present invention;

FIG. 4 shows another additional preferred embodiment of a cellular telephone system according to the present invention;

FIG. 5 shows a third additional preferred embodiment of a cellular telephone system according to the present invention;

FIG. 6 shows a fourth preferred embodiment of a cellular telephone system according to the present invention;

FIG. 7 shows a fifth preferred embodiment of a cellular telephone system according to the present invention;

FIG. 8 shows a sixth additional preferred embodiment of a cellular telephone system according to the present invention;

FIG. 9 shows a seventh additional preferred embodiment of a cellular telephone system according to the present invention;

FIG. 10 is a cross sectional view of two acoustical tubes according to the present invention fused alongside one another;

FIG. 11 is a cross sectional view of an alternate preferred embodiment of two acoustical tubes according to the present invention;

FIG. 12 is a cross sectional view of two concentric acoustical tubes according to the present invention;

FIG. 13 is a diagram of a typical transmitter of acoustical signals according to the present invention;

FIG. 14 is a diagram of a typical receiver for acoustical signals according to the present invention;

FIG. 15 is a diagram of a preferred embodiment of a conversion device according to the present invention;

FIG. 16 is a diagram of an alternate preferred embodiment of a conversion device according to the present invention;

FIG. 17 is a flow chart describing a method for reducing radiation exposure to a user of a cellular telephone;

### DETAILED DESCRIPTION OF THE INVENTION

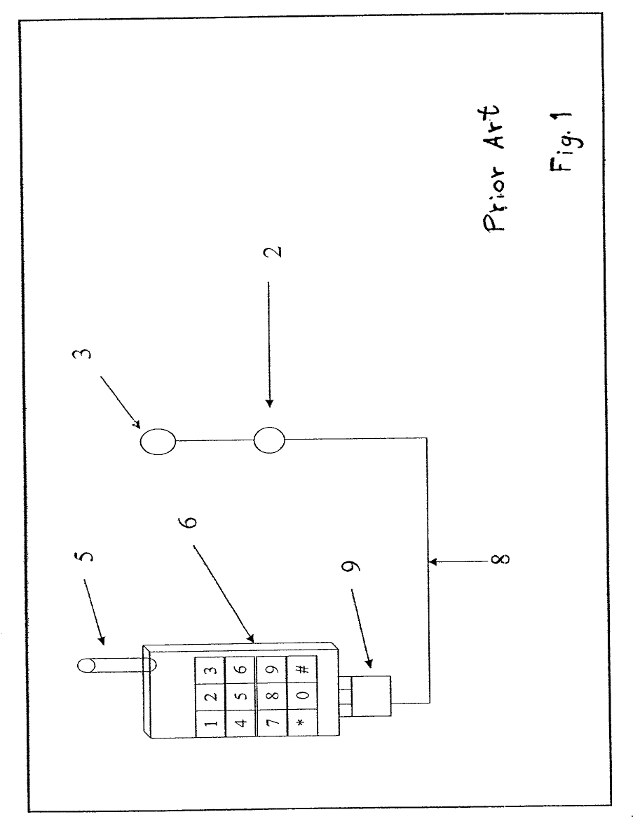

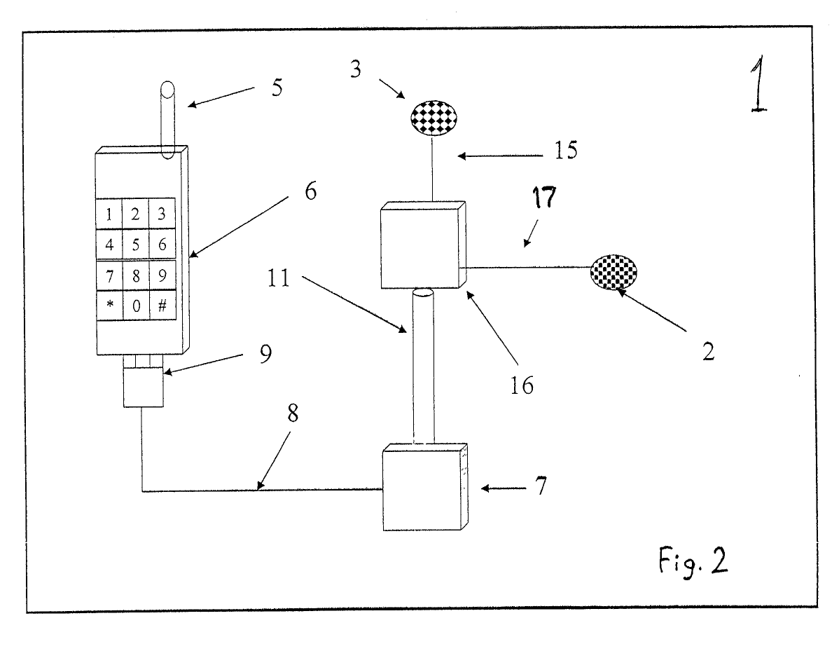

For purposes of better understanding of the present invention, as illustrated in FIGS. 2 through 15, reference is first made to the construction and operation of a conventional prior art transmission device pictured here as a cell phone as illustrated in FIG. 1. Such a conventional cell phone 6 may be connected to electrical microphone 2 and an earphone 3 via an electrical wire 8. Wire 8 and antenna 5, are sources of electromagnetic radiation which present potential health hazards to the user.

The principles and operation of system and method for radiation-free transmission device pictured here as a cellular telephone communication according to the present invention may be better understood with reference to the drawings and accompanying descriptions.

The cellular telephone system 1 of the present invention may contain two conversion devices 7 and 16 as illustrated in FIG. 2. In such a case, telephone 6 is connected to a proximal conversion device 7 via an electrical wire 8. Conversion device 7 is connected to a distal conversion device 16 with an acoustical tube 11. Distal conversion device 16 is connected to electrical earphone 3 and electrical microphone 2 with electrical wires 15 and 17. Proximal conversion device 7 may be connected directly to telephone 6 or may be an integral part of telephone 6.

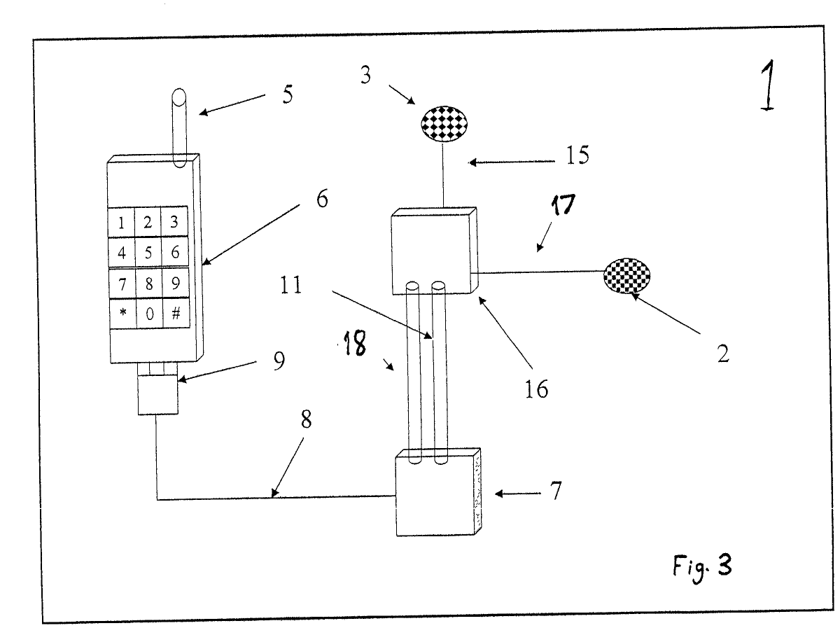

In another preferred embodiment system 1 (FIG. 3) contains two conversion devices 7 and 16. In this configuration telephone 6 is connected to proximal conversion device 7 via electrical wire 8. Conversion device 7 is connected to distal conversion device 16 with acoustical tubes 11 and 18. Distal conversion device 16 is connected to electrical earphone 3 and electrical microphone 2 with electrical wires 15 and 17, respectively. Proximal conversion device 7 may be connected directly to telephone 6 or may be an integral part of telephone 6.

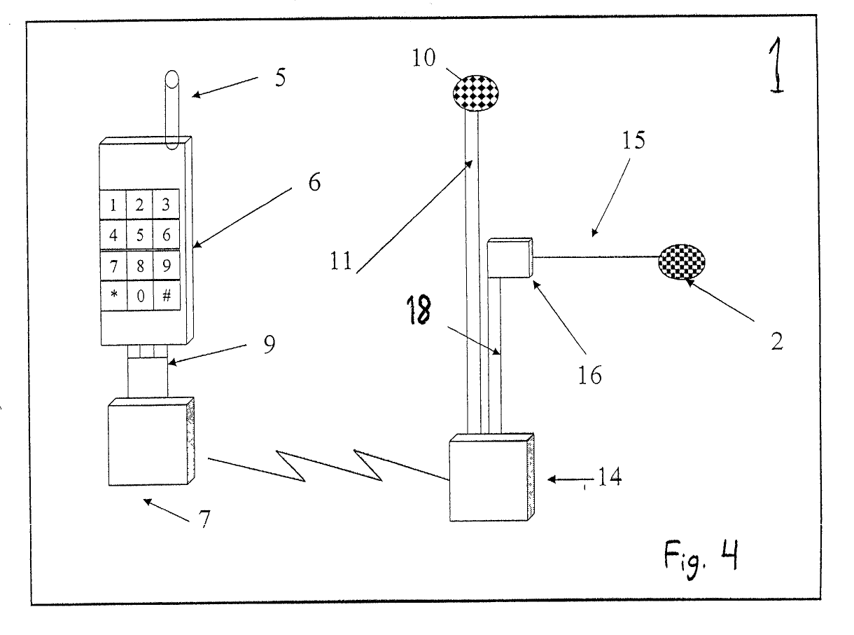

In another preferred embodiment of system 1 (FIG. 4) a transmission device pictured here as a cellular telephone 6 is connected to proximal conversion device 7 via an electrical coupler 9. Conversion device 7 is coupled to conversion device 14 by sending and receiving electromagnetic signals. Conversion device 14 is coupled to acoustical earphone 10 via acoustical tube 11. Electric signals are transmitted from electrical microphone 2 to conversion device 16 via electrical wire 15. Conversion device 14 is coupled to conversion device 16 by acoustical tube 18 which transmits acoustical signals from conversion device 16 to conversion device 14.

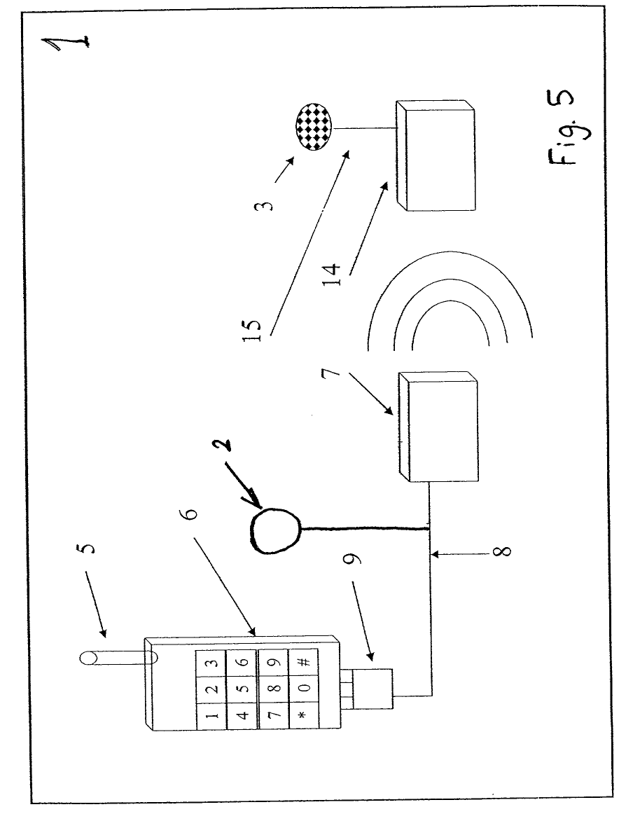

In another preferred embodiment of system 1 (FIG. 5), a transmission device pictured here as a cellular telephone 6 may be connected to conversion device 7 via electrical wire 8 and electrical coupler 9. Conversion device 7 converts electrical signals into acoustical signals that in turn are transmitted to conversion device 14 that converts them back to electric signals that in turn are transmitted to electrical earphone 3 via electrical wire 15. Electrical microphone 2 is coupled to cellular telephone 6 via an electrical wire 8 and electrical coupler 9.

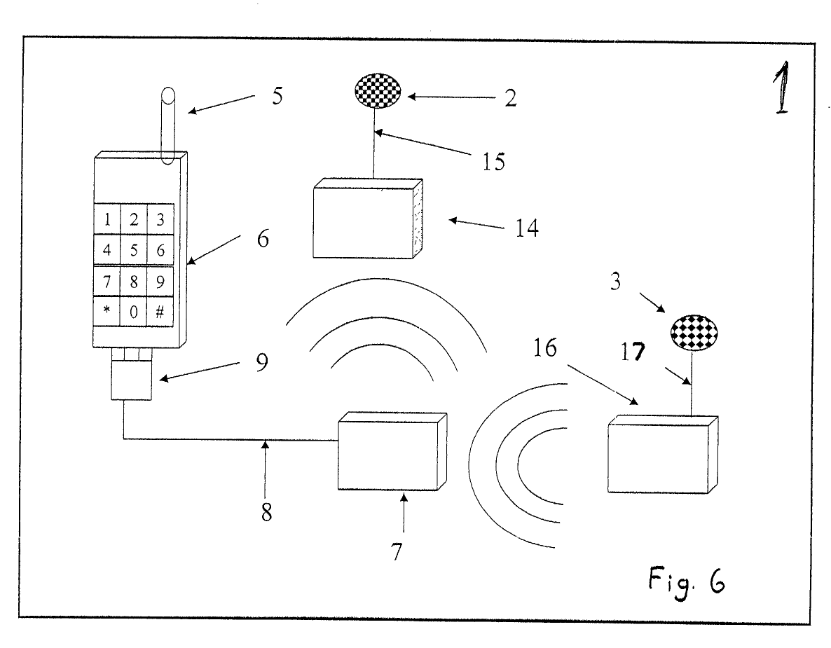

In another preferred embodiment of system 1 (FIG. 6), a transmission device pictured here as a cellular telephone 6 is connected to conversion device 7 via electrical wire 8 and electrical coupler 9. Conversion device 7 converts electrical signals into acoustical signals that in turn are transmitted to conversion device 14. Electrical signals are transmitted from conversion device 14 to electrical earphone 2 via electrical wire 15. Also, Conversion device 7 converts acoustical signals received from conversion device 16 into electrical signals that in turn are transmitted to telephone 6 via electric wire 8 and electric coupler 9. Electrical signals are transmitted from electrical microphone 3 to conversion device 16 via electrical wire 17.

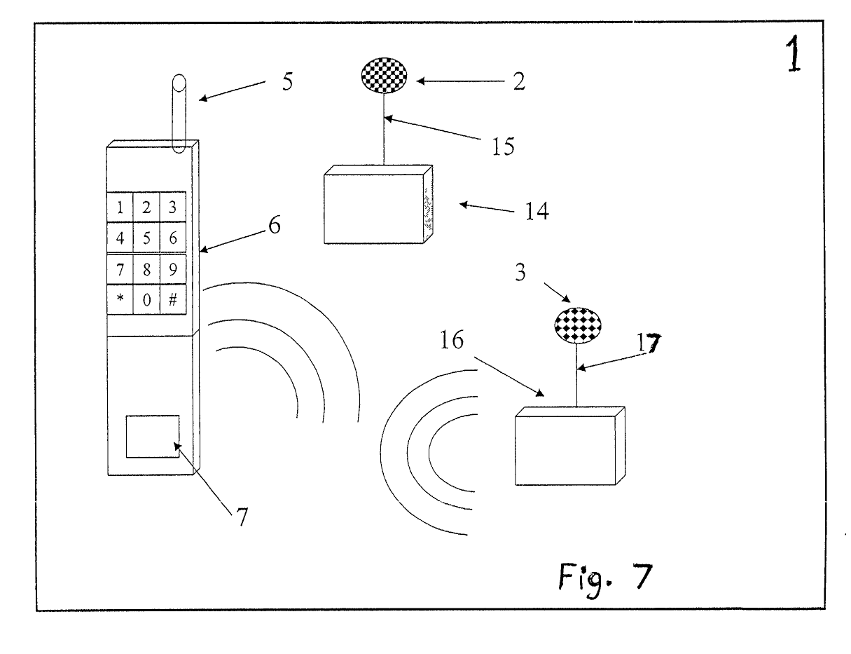

In another preferred embodiment of system 1 (FIG. 7), a transmission device pictured here as a cellular telephone 6 is connected to proximal conversion device 7 via electrical coupler 9. Conversion device 7 converts electrical signals into acoustical signals that in turn are transmitted to conversion device 14. Electrical signals are transmitted from conversion device 14 to electrical earphone 2 via electrical wire 15. Also, Conversion device 7 converts acoustical signals received from conversion device 16 into electrical signals that in turn are transmitted to telephone 6 via electric coupler 9. Electrical signals are transmitted from electrical microphone 3 to conversion device 16 via electrical wire 17.

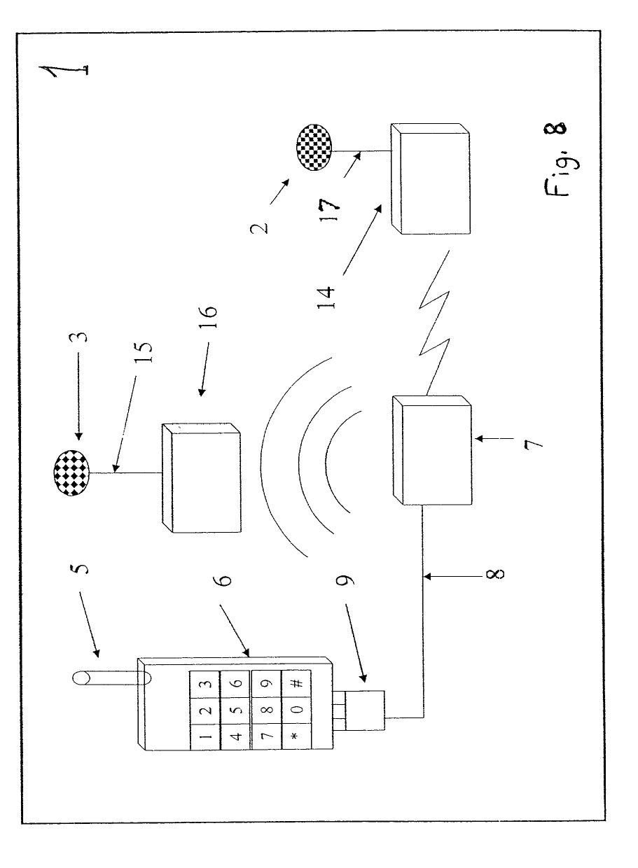

In another preferred embodiment of system 1 (FIG. 8), a transmission device pictured here as a cellular telephone 6 is connected to conversion device 7 via electrical wire 8 and electrical coupler 9. Conversion device 7 converts electrical signals into acoustical signals that in turn are transmitted to conversion device 16. Electrical signals are transmitted from conversion device 16 to electrical earphone 3 via electrical wire 15. Also, Conversion device 7 converts electromagnetic signals received from conversion device 14 into electrical signals that in turn are transmitted to telephone 6 via electric wire 8 and electric coupler 9. Electrical signals are transmitted from electrical microphone 2 to conversion device 14 via electrical wire 17.

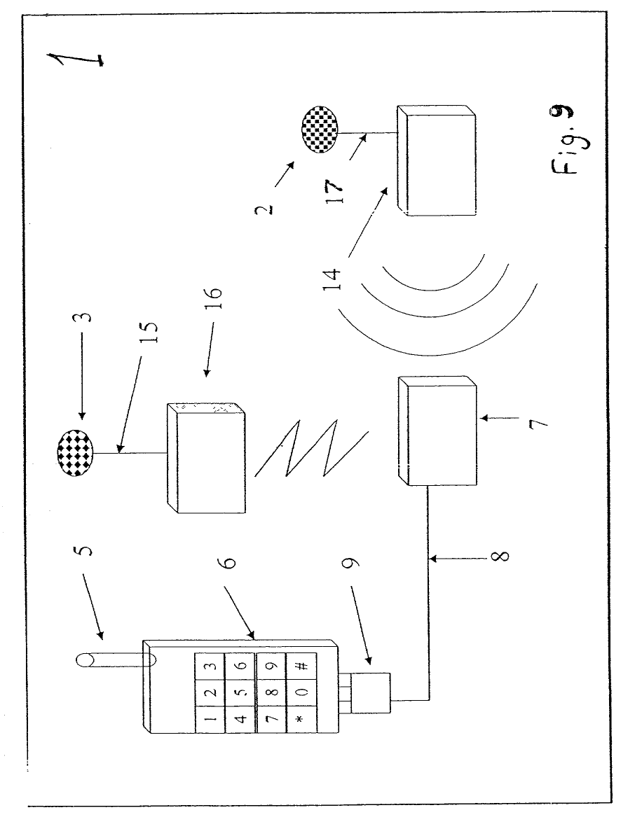

In another preferred embodiment of system 1 (FIG. 9), a transmission device pictured here as a cellular telephone 6 is connected to conversion device 7 via electrical wire 8 and electrical coupler 9. Conversion device 7 converts electrical signals into electromagnetic signals that in turn are transmitted to conversion device 16. Electrical signals are transmitted from conversion device 16 to electrical earphone 3 via electrical wire 15. Also, conversion device 7 converts acoustical signals received from conversion device 14 into electrical signals that in turn are transmitted to telephone 6 via electric wire 8 and electric coupler 9. Electrical signals are transmitted from electrical microphone 2 to conversion device 14 via electrical wire 17.

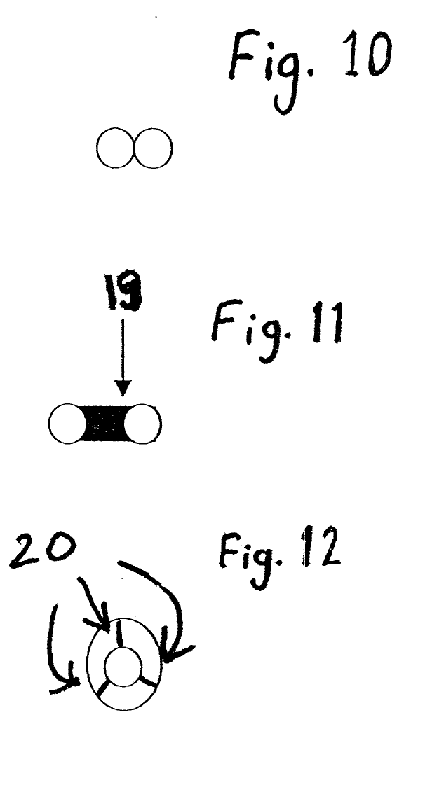

Acoustical tube 11, is typically constructed of (electrically) non-conducting material. This non-conducting material is preferably a flexible material such as, for example, polyethylene, polypropylene, polyvinylchloride (PVC). Acoustical tube 11 is preferably filled with a medium capable of conducting acoustical waves selected from the group consisting of ultrasonic waves and subsonic waves. The medium may be selected from a group including, but not limited to, plasma, a gas (e.g. air), a liquid, or a solid. Transmitted signal and received signal may be conveyed by same one acoustical tube. However, instead of one tube 11, two tubes 11 and 18 can be employed, one for receiving and another for transmission. Tubes 11 and 18 may be fused together in essentially any configuration. For example, they may be side by side (FIG. 10), separated by a web 19 (FIG. 11), wrapped together side by side or one inside the other, for example as concentric tubes separated by fins 20 between their walls (FIG. 12).

Branching may appear at any position along a tube. A tube with multiple branching tubes may be used as an announcement system for internal communication. Such internal communication might find utility, for example, among the crew of a vehicle, an airplane or a seagoing vessel.

The cross-section of tube 11 may be round, square or of any other geometry. One or more acoustical fittings such as quarter wavelength plate, a membrane or a funnel may be installed or embedded in tube 11.

Conversion devices 7, 14 and 16 are essential parts of the invention. Each one of them contain at least one transducer. For purposes of this specification and the accompanying claims, the term “transducer” is defined as a device which is capable of converting at least one first signal type to at least one second signal type. For purposes of this specification “signal type” includes, but is not limited to electrical signals, acoustical signals and electromagnetic signals. Conversion devices 7, 14 and 16 contain a transceiver for converting electromagnetic signals and/or acoustical signals. In addition, conversion devices 7, 14, and 16 may contain one or more additional components including but not limited to: an encryption device, a decoder, an amplifier circuit, a filter circuit, an internal power supplier, redundantly operated, a micro controller, a wireless transmitter/receiver, a device for sending a signal to any entrance or any exit of the conversion device, a device for changing a signal to any entrance or any exit of the conversion device and a device that can control transmission of any signal to any entrance or any exit of the conversion device.

Exemplary preferred embodiments of conversion devices are shown in FIGS. 13, 14, 15 and 16.

As an illustrative example of a preferred embodiment (FIG. 13), the invention includes a transmitter that receives electrical signal via electrical filter 71. Oscillator 72 emits alternating signal. Gate 74 combines these signals. The combined signal is amplified by amplifier 52 and enters speaker 50.

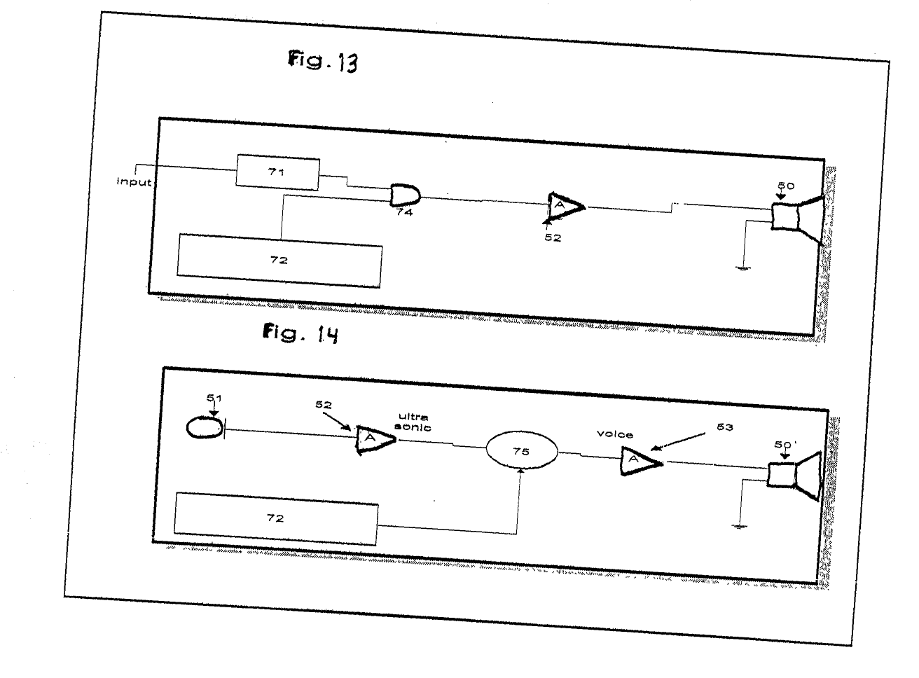

In another preferred embodiment shown in FIG. 14, the invention includes a receiver including electrical microphone 51 that receives acoustical signals that are amplified by amplifier 52. Oscillator 72 emits an alternating signal. Mixer 75 converts the signal coming from amplifier 52 to signal of wave frequency by using the alternating signal coming from oscillator 72. The signal emitted from the mixer amplified by amplifier 53 and enters speaker 50.

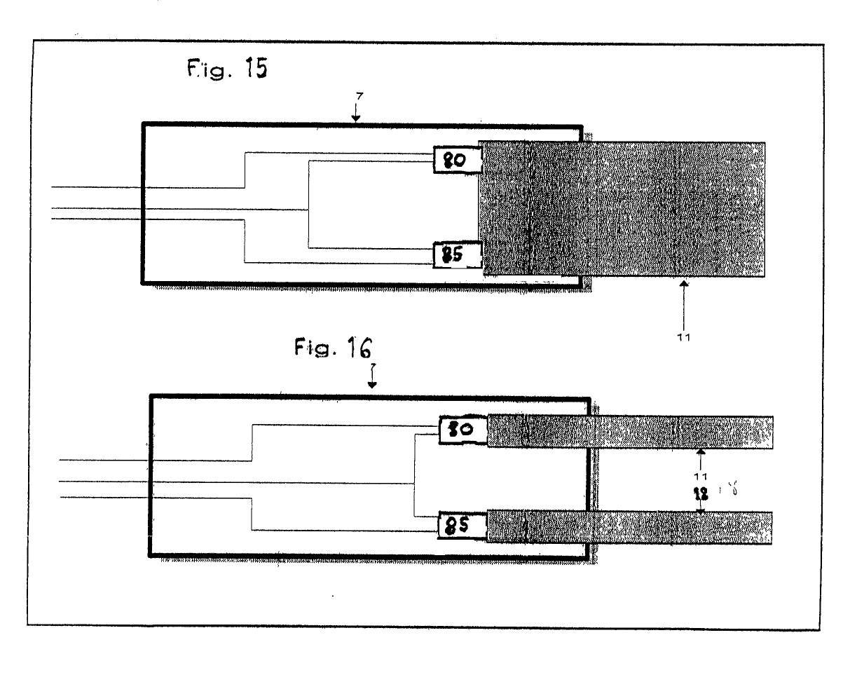

Further, the invention may include conversion device 7 as shown in FIG. 15. Conversion device 7 includes transmitter 80 and receiver 85, both are coupled to acoustical tube 11.

Still Further, the invention may include conversion device 7 as shown in FIG. 16. Conversion device 7 includes transmitter 80 and receiver 85, each of which is coupled to separate acoustical tubes 11 and 18.

Acoustical signals referred to hereafter are ultrasonic or subsonic mechanical waves, excluding acoustical signals transmitted to acoustical earphone through acoustical tube.

The use of an amplifier improves the transmission of waves and especially required for the transmission of wave over long distances.

The internal power supply may be a battery, a solar cell, a wind vane, an apparatus for coupling kinetic energy to conversion device, or any other energy source. The power supply may be connected to an amplifier.

Typical amplifiers are described in Ralph J. Smith, Circuits, Devices and Systems, second edition (1971), pp. 365, FIG. 11.21 and pp. 376, FIG. 11.31(a) And in 305 Circuits, Elcktor Elecktronice publishing (1995), ISBN 090570536x, pp. 19, FIG. 924053-11.

Typical microphone amplifier circuit configurations are described in 305 Circuits, Elcktor Elecktronice publishing, ISBN 090570536x, pp. 33, FIG. 934039-11.

Typical filter circuit configurations are described in Ralph J. Smith, Circuits, Devices and Systems, second edition (1971), pp. 404, FIGS. 12.15(a), and 12.16(a) and in 305 Circuits, Elcktor Elecktronice publishing, ISBN 090570536x, pp. 31, FIG. 924095-11.

Typical wave rectifier circuit configurations are described in Ralph J. Smith, Circuits, Devices and Systems, second edition (1971), pp. 393, FIG. 12.3(a) and in 305 Circuits, Elcktor Elecktronice publishing, ISBN 090570536x, pp. 14, FIG. 914122-11; page 137, FIG. 934024-11.

Typical relay circuit configurations are described in 305 Circuits, Elcktor Elecktronice publishing, ISBN 090570536x, pp. 14, FIG. 914122-11.

Typical charger circuit configurations are described in 305 Circuits, Elcktor Elecktronice publishing, ISBN 090570536x, pp. 96, FIG. 914004-11; pp. 103, FIG. 914047-11.

An electrical microphone is defined as a device for the conversion of mechanical waves into an electrical signal. An electrical earphone is defined as a device for the conversion of an electrical signal into mechanical waves. An acoustical earphone is defined as a device that is attached to an opening of an acoustical tube, positioned in the ear of a user of the invention and is capable of conveying a mechanical wave.

An electrical coupler is a device at one end of a wire or a conversion device with which it is attached to an input/output port of a cellular telephone.

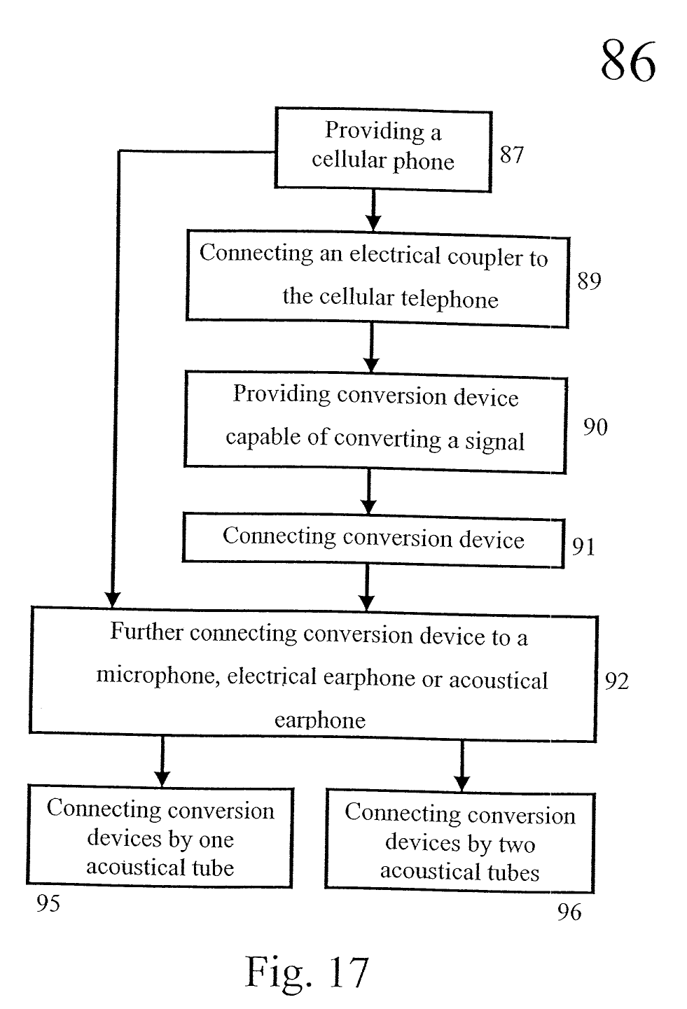

The invention is further embodied by a method 86 for reducing radiation exposure to a user of a cellular telephone, as described in FIG. 17. When cellular phone 6 provided 87 is not integrally formed with an electrical coupler and at least one conversion device 7, an electrical coupler 9 is connected 89 to the cellular telephone 6. At least one item selected from the group consisting of electrical microphone 2 and a conversion device 7 connectable to the telephone 6 and capable of converting a signal of a first type to a signal of a second type is provided 90 and connected 91 to the cellular phone 6, wherein signals are independently selected from the group consisting of electrical signal, acoustical signal and electromagnetic signal. At least one conversion device 7 will be further connected 92 to at least one item selected from the group consisting of electrical microphone 2, an electrical earphone 3 and an acoustical earphone 10.

In a cellular phone 6 integrally formed 87 with at least one item selected from the group consisting of an electrical coupler and at least one conversion device, said at least one conversion device will be further connected 92 to at least one item selected from the group consisting of electrical microphone 2, an electrical earphone 3 and an acoustical earphone 10.

Whenever an acoustical tube is required for connecting conversion devices, and signals transmitted in opposite directions can be conveyed in one acoustical tube, then conversion devices 7 and 16 are connected 95 by one acoustical tube 11. When signals transmitted in opposite directions can not be conveyed in one acoustical tube, conversion devices 7 and 16 are connected 96 by one acoustical tube for each direction, wherein conveying of said acoustical signal in a first direction occurs in a first acoustical tube 11, and conveying of said acoustical signal in a second direction occurs in a second acoustical tube 18. First and second acoustical tubes may be, for example, connected to one another or concentric.

A transmission device may be for example a cell phone, a wireless transmitter/receiver, a computer or it's component, a CD player, a tape recorder, a DVD, a video camera or any other means of communication. When data is transmitted, electrical signals are converted into mechanical waves and vice versa.

In addition, the transmission of mechanical waves is insensitive to surrounding electromagnetic field.

Additional objects, advantages, and novel features of the present invention will become apparent to one ordinarily skilled in the art upon examination of the figures, which are not intended to be limiting.

1. A system to reduce radiation exposure to a user of a transmission device, the system comprising:
(a) the transmission device;
(b) at least one conversion device connectable to the transmission device, wherein each of said at least one conversion device is capable of converting a signal of a first type to a signal of a second type, said at least one conversion device being further connectable to at least one item selected from the group consisting of an electrical microphone, an electrical earphone, an acoustical microphone and an acoustical earphone; and
(c) an electrical coupler attachable to the transmission device, said electrical coupler being electrically coupled to at least one item selected from the group consisting of said conversion device and said electrical microphone.

2. The system of claim 1, said system comprising:
(i) A first conversion device being electrically coupled to said electrical wire, said electrical wire being electrically coupled to said electrical coupler, said electrical coupler being electrically coupled to said transmission device.
(ii) A second conversion device being electrically coupled to said electrical wire, said electrical wire being electrically coupled to said electrical microphone.
(iii) A third conversion device being electrically coupled to said electrical wire, said electrical wire being electrically coupled to said electrical earphone.

3. The system of claim 2, wherein said first conversion device is attached to or integrally formed with the transmission device.

4. The system of claim 1, wherein said signal of a first type and said signal of a second type are each independently selected from the group consisting of an electric signal, an acoustical signal and an electromagnetic signal.

5. The system of claim 1, wherein at least one item selected from the group consisting of said electrical coupler and said at least one conversion device are attached to or integrally formed with the transmission device.

6. The system of claim 4, wherein said acoustical signal is conveyed by at least one acoustical tube.

7. The system of claim 6, wherein said acoustical signal travels in a first direction via a first acoustical tube, and travels in a second direction via a second acoustical tube.

8. The system of claim 7, wherein said first and second acoustical tubes are assembled in any way selected from the group consisting of:
(i) connecting said tubes to one another; and
(ii) making said tubes concentric.

9. A conversion device for converting signals, the conversion device comprising a transducer.

10. The conversion device of claim 9, wherein said signal of a first type and said signal of a second type are each independently selected from the group consisting of an electric signal, an acoustical signal and an electromagnetic signal.

11. The conversion device of claim 9, further comprising at least one additional components selected from the group consisting of an encryption device, a decoder, an amplifier circuit, a filter circuit, an internal power supply, a micro controller, a wireless transceiver, a device for sending a signal to any entrance or any exit of the conversion device, a device for changing a signal to any entrance or any exit of the conversion device and a device that can control transmission of any signal to any entrance and any exit of the conversion device.

12. A method for reducing radiation exposure to a user of a transmission device, the method comprising the steps of:
(a) providing at least one conversion device connectable to the transmission device and capable of converting a signal of a first type to a signal of a second type;
(b) connecting said at least one conversion device to the transmission device;
(c) further connecting said at least one conversion device to at least one item selected from the group consisting of an electrical microphone, an electrical earphone, an acoustical microphone and an acoustical earphone; and
(d) further connecting an electrical coupler to the transmission device, wherein said electrical coupler is electrically coupled to at least one item selected from the group consisting of said conversion device and an electrical microphone.

13. The method of claim 12, wherein said signal of a first type and said signal of a second type are each independently selected from the group consisting of an electric signal, an acoustical signal and an electromagnetic signal.

14. The method of claim 12, comprising the additional step of attaching to or integrally forming with the transmission device at least one item selected from the group consisting of said electrical coupler and said at least one conversion device.

15. The method of claim 13, comprising the additional step of conveying said acoustical signal by an acoustical tube.

16. The method of claim 15, wherein conveying of said acoustical signal in a first direction occurs in a first acoustical tube, and conveying of said acoustical signal in a second direction occurs in a second acoustical tube.

17. The method of claim 16, comprising the additional step of connecting said tubes in a way such that they will be in a configuration selected from the group consisting of:
(i) tubes that are connected to one another; and
(ii) concentric tubes.
